(19) United States
(12) Patent Application Publication
(10) Pub. No.: US 2011/0030033 A1
(43) Pub. Date: Feb. 3, 2011

(54) MANAGING SECURE USE OF A TERMINAL

(75) Inventor: Frédéric Rousseau, Montigny Le Bretonneux (FR)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: EADS SECURE NETWORKS, ELEANCOURT (FR)

(21) Appl. No.: 12/936,891

(22) PCT Filed: Apr. 7, 2009
(86) PCT No.: PCT/FR09/50604

§ 371 Date: Oct. 7, 2010

(30) Foreign Application Priority Data
Apr. 8, 2008 (FR) 0852341

(51) Int. Cl. H04L 9/32

(52) U.S. Cl. 726/3

(57) ABSTRACT

A terminal exhibits at least one functionality made secure on the basis of a security item. A security entity stores said security item as well as first authentication parameters. The terminal stores second authentication parameters. At the level of the terminal, an authentication of the security entity is performed on the basis of the first and second authentication parameters. Next, a secure contactless link is established with the security entity. Finally, the security item stored on said security entity is received in the course of said secure link.

### PRIORITY CLAIM

This application is a 371 filing from PCT/FR2009/050604, filed Apr. 7, 2009, which claims priority from French Application for Patent No. 0852341, filed Apr. 8, 2008, the disclosures of which are hereby incorporated by reference.

### TECHNICAL FIELD

This invention relates to the level of security in the use of a terminal, and more particularly to a context of multi-user terminal use, meaning when the terminal is likely to be used by several users in succession. It has particular applications in the field of secure communications when a multi-user communications terminal is likely to be used by multiple users in succession, including users belonging to different organizations.

### BACKGROUND

In order to guarantee a certain level of security in terminal use, or in other words to avoid identity theft aiming at fraudulent terminal use, a set of terminal functions may initially be non-operational and only become so upon receipt of certain data. This is the case in a scenario defined in the TETRA standard (Terrestrial Trunked Radio), and more specifically in ETSI document EN 300 392-7 on TETRA security (ETSI is the European Telecommunications Standards Institute).

In such a scenario, certain functionalities of a terminal can only be used with the aid of identity parameters which are stored on a specific card. These identity parameters can correspond to the ITSI (Individual TETRA Subscriber Identity) and to a key K, or to the ITSI plus a key KS (for Session Key) and a key RS (for Random Seed). The specified use for these identity parameters enables compartmentalizing of the secure use of the different communication services offered to the user.

The ITSI is a card inserted into the terminal. It provides security in using the terminal but does not allow easily changing the terminal user.

The invention provides a solution to the problem.

### SUMMARY

A first aspect of the invention provides a method for managing the secure use of a terminal having at least one functionality made secure on the basis of a security data item, with a security entity storing said security data item and first authentication parameters, and with the terminal storing second authentication parameters,
said method comprising the following steps, at the terminal:
/1/ performing an authentication of the security entity on the basis of the first and second authentication parameters,
/2/ establishing a contactless secure link with the security entity, and
/3/ receiving, during said contactless secure link, the security data item stored on said security entity.

In such an embodiment, a terminal requires a security data item to enable the use of at least one functionality of this terminal. This security data item is initially stored on a security entity, which can also be referred to as a user card, and the terminal is responsible for retrieving it from this security entity. It is advantageous to perform this retrieval of the security data item via a contactless secure link which was only established once the terminal was able to authenticate this security data item. This prior authentication step, based on information stored both on the terminal and on the security entity, guarantees a level of security in the use of this terminal.

Through such measures, it is possible to receive the security data item at the terminal in a secure manner because the security entity and the terminal each have information enabling them to apply a reciprocal authentication, or a mutual authentication, between them.

By applying such an authentication prior to establishing this secure link for sending the security data item from the security entity to the terminal, a high level of security in the use of the terminal can be guaranteed.

Advantageously, once the security data item is sent according to the management method of an embodiment of the invention, the terminal can then make the corresponding functionality available. The terminal can be used by the corresponding user, even if the link between the security entity and the terminal is later interrupted.

It should be noted that in the prior art, the level of security associated with the use of the terminal is guaranteed in particular by the fact that the security entity, or user card, is kept in contact with the terminal by mechanical means, and more specifically is positioned inside it. The use of the terminal is therefore only possible when the security entity is present.

In an embodiment of the invention, the level of security in using the terminal rests on the prior authentication of the entity and the terminal, as well as on the secure transmission of the security data item from the security entity to the terminal. Thus, since the level of security in using the terminal does not require the presence of the security entity, maintaining a link between the terminal and the security entity during use of the terminal is not required. Once the security data item has been sent to it, the terminal can be used without a link between the security entity and itself.

In addition, with such a management method, it is possible to change the terminal user easily, without having to perform a mechanical action followed by an electrical initialization, such as is the case when the security entity is placed in the terminal and mechanically retained inside it.

In this case, the level of security in using a terminal rests on the mutual authentication between terminal and security entity. Because of this, the secure link established between the security entity and the terminal can be contactless and can be established temporarily, simply to allow transmission of the security data item. It is then easy to implement a change of terminal user under such conditions.

Such a management method can therefore be advantageously implemented for multi-user terminal use.

In one embodiment of the invention, at least one first management unit is in charge of managing security parameters related to terminals and at least one second management unit is in charge of managing security parameters related to terminal users. In this context, the first authentication parameters which are stored on the security entity can correspond to a first security parameter provided by the second management unit and a second security parameter indicating the first management unit; and the second authentication parameters which are stored on the terminal can correspond to a third security parameter provided by the first management unit and a fourth security parameter indicating the second management unit.

In one embodiment of the invention, erasure of the security data item on the terminal is performed when an action occurs at the terminal, and in such case, the terminal notifies the security entity of this erasure.

In this manner, the security entity can be informed both of the transmission of the security data item to a terminal, and of the erasure of this security data item at said terminal. It can therefore manage a utilization state for the security data item which it stores for one or more terminals in an embodiment of the invention.

In one embodiment, prior to step /3/, the terminal registers itself with a network on the basis of an identifier previously stored on the terminal. Thus, even before the terminal has retrieved a security data item from a security entity, it is able to register with the network. It can therefore have access to at least some of the services offered by this network on the basis of an identifier specific to it, meaning one that may not be tied to the terminal user.

After step /3/, the terminal can register with a network on the basis of a secure identifier obtained based on the security data item.

In this case, the terminal is registered on the basis of an identifier related to the user. It can be arranged so that the services the terminal can access after such a registration based on a user identifier are more numerous than those the terminal can access with a simple registration based on an identifier previously stored on the terminal, which can be an identifier specific to the terminal.

A second aspect of the invention provides a method for managing the secure use of a terminal having at least one functionality that is made secure on the basis of a security data item, with a security entity storing said security data item and first authentication parameters, and with the terminal storing second authentication parameters, said method comprising the following steps, at the security entity:
/1/ performing an authentication of the terminal on the basis of the first and second authentication parameters,
/2/ establishing a contactless secure link with the terminal, and
/3/ sending to the terminal, during said contactless secure link, the stored security data item.

When at least one first management unit is in charge of managing security parameters related to terminals and at least one second management unit is in charge of managing security parameters related to users of said terminals, the first authentication parameters stored on the security entity can correspond to a first security parameter provided by the second management unit and a second security parameter indicating the first management unit, and the second authentication parameters stored on the terminal can correspond to a third security parameter provided by the first management unit and a fourth security parameter indicating the second management unit.

The security entity can manage a utilization state which is updated:
upon transmission of the security data item to a terminal, and
upon receipt of notification that the security data item has been erased from the terminal.

A third aspect of the invention provides a terminal adapted to implement a management method according to the first aspect of the invention.

A fourth aspect of the invention provides a security entity adapted to implement a management method according to the second aspect of the invention.

A fifth aspect of the invention provides a system for managing the secure use of a terminal, comprising a terminal according to the third aspect of the invention and a security entity according to the fourth aspect of the invention.

### BRIEF DESCRIPTION OF THE DRAWINGS

Other aspects, objects, and advantages of the invention will be apparent upon reading the following description of one its embodiments. The invention will also be better understood through the drawings, in which:

FIG. 1 illustrates the main steps of a management method according to an embodiment of the invention,

FIG. 2 illustrates an architecture of a terminal and a security entity according to an embodiment of the invention,

FIG. 3 illustrates an exchange of messages concerning the management of a secure identifier within a terminal between different functionalities of said terminal, in an embodiment of the invention,

FIG. 4 illustrates an exchange of messages concerning the management of a secure identifier between different functionalities of a terminal when the terminal is already registered with a network on the basis of its own specific identifier, and

FIG. 5 illustrates messages exchanged in order to erase a security data item stored on a terminal according to an embodiment of the invention.

### DETAILED DESCRIPTION OF THE DRAWINGS

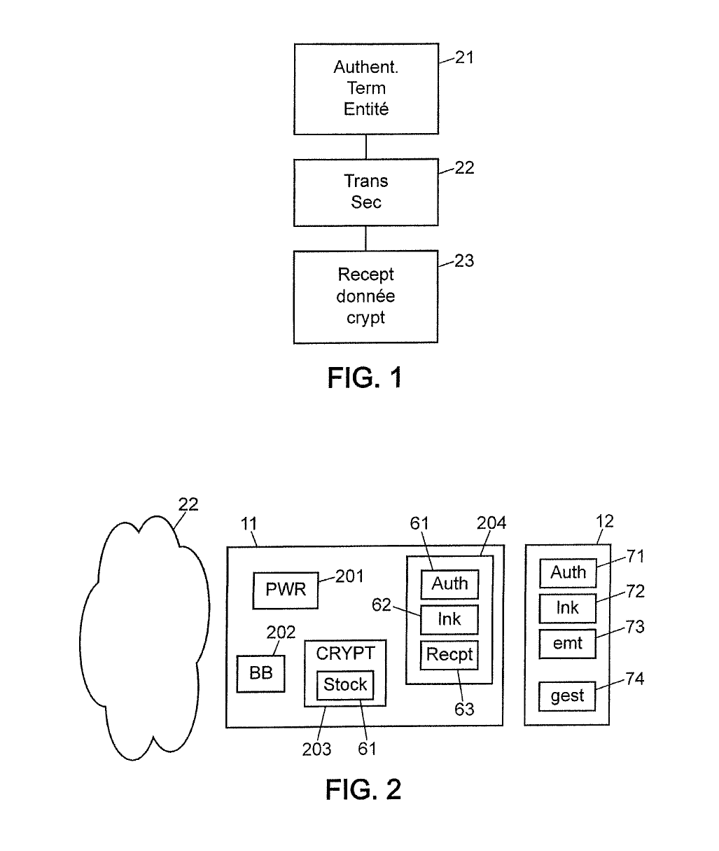

FIG. 1 illustrates the main steps of a management method according to an embodiment of the invention. These steps are performed at a terminal.

A terminal according to an embodiment of the invention performs at least one functionality which is initially locked. A “locked functionality” is understood to mean that the functionality cannot be used at the terminal without it first being unlocked on the basis of a security data item.

A “security data item” is understood to mean a cryptographic key or access control parameters.

In order to use at least one specific function of the terminal according to an embodiment of the invention, a security data item which unlocks the locked functionality of the terminal is retrieved.

Such a security data item can advantageously be stored on any storage medium which is able both to store this security data item and to communicate with the terminal concerned.

No limitation is placed on the invention concerning the security entity which stores the security data item.

In order to guarantee a certain level of security in using the terminal according to an embodiment of the invention, the security data item stored on a security entity is only transferred after an authentication step 21. This authentication step allows the terminal to authenticate a security entity from which it is likely to receive a security data item unlocking one of its functionalities. On the basis of this step 21, the terminal is able to verify that the security entity is an entity from which it can receive data in a secure manner. Thus, the use of the terminal, or more specifically the unlocking of the locked functionality on this terminal, is subjected to a verification which guarantees a level of security concerning the identity of the terminal user.

This authentication step is based on information shared between the terminal and the security entity. Thus, authentication parameters are stored on the terminal which allow it to authenticate itself with the entity and to authenticate the entity. The same is true on the entity side, which stores authentication parameters which allow it to authenticate itself with the terminal and to authenticate the terminal. Such a mutual authentication is advantageously implemented before the contactless secure link is established.

In one embodiment of the invention, these authentication parameters correspond to different types of security parameters concerning different organizations. The organizations are responsible for providing such security parameters both for terminals and for users of these terminals, such that the use of these terminals is secure.

A first management unit is therefore in charge of managing the security parameters for the terminals and a second management unit is in charge of managing the security parameters for the security entities, meaning user cards, which allow a user to use one of the terminals.

The first management unit is adapted to generate first security parameters for the terminals, all these first security parameters being associated with a single security parameter, denoted term_public_credential, which indicates the first management unit.

The second management unit is adapted to generate second security parameters for terminal users, all these second security parameters being associated with a unique security parameter, denoted org_public_credential, which indicates the second management unit.

The first and second security parameters may, for example, correspond to respective pairs of keys consisting of a private key and a public key. They may also correspond to asymmetric cryptography certificates.

The unique security parameters indicating a management unit can correspond to public keys, on the basis of which the identity of the management unit providing the security parameters can be verified.

On the terminal, there can be a stored security parameter indicating the second management unit, meaning the one in charge of managing the security parameters related to the users, and therefore the security entities, and also at least one security parameter provided by the first management unit.

Conversely, on a security entity, there can be a stored security parameter indicating the first management unit, and also a security parameter provided by the second management unit.

On these basis of these security parameters, the terminal can verify that the corresponding security entity belongs to a user who is authorized to use it. The terminal receives the security parameter provided by the second management unit from the security entity, and can thus determine whether this security parameter was provided by the second management unit indicated by the security parameter it has stored. The same operation can be conducted at the security entity as well.

The mutual authentication between the terminal and the security entity can be implemented on the basis of a known protocol, for example when establishing a key as defined in ISO/IEC 11770-2 “Information technologies—Security techniques—Key management—Part 3: Mechanisms using asymmetrical techniques”.

In the case where the security parameters stored on the terminal and on the security entity are not consistent with each other, for example when their respective management units do not authorize the terminal and the security entity to cooperate, it can be arranged so that the authentication step fails and the process is then stopped.

Once the terminal has authenticated the security parameters and the security entity has authenticated the terminal, a secure link between the terminal and the security entity can then be established in a step 22. This secure link can be established using any type of protocol for establishing a key or key transport, for examples those defined in ISO/IEC 11770-2.

Next, in a step 23, the security entity sends the security data item to the terminal. The terminal stores it. This security data item allows it to unlock the functionality which was initially locked.

A user who possesses a security entity can then access the corresponding function of the terminal, meaning the function which can be performed because the terminal functionality has been unlocked. For example, the terminal may provide certain services offered on a network through the unlocked functionality.

Once the security data item is stored on the terminal, the link between the terminal and the corresponding security entity no longer needs to be maintained. It is sufficient for this link to be established temporarily for transmitting the security data item.

FIG. 2 illustrates an architecture of a terminal and a security entity according to an embodiment of the invention.

A terminal 21 according to an embodiment of the invention comprises:
an authentication unit 61 adapted to perform an authentication 21 of the security entity on the basis of the first and second authentication parameters,
a link management unit 62 adapted to establish 22 a contactless secure link with the security entity, and
a receiver 63 adapted to receive 23, during said contactless link, the security data item stored on said security entity.

The terminal can additionally comprise a storage management unit 64 adapted to store the security data item received and to erase it when a specific action occurs.

In one embodiment of the invention, a security entity comprises:
an authentication unit 71 adapted to perform an authentication of the terminal on the basis of the first and second authentication parameters,
a link management unit 72 adapted to establish 22 a contactless secure link with the terminal, and
a transmitter 73 adapted to transmit the stored security data item during said contactless secure link.

It can additionally comprise a state management unit 74 adapted to update a state:
upon transmission of the security data item to the terminal, and
upon receipt of a notification that the security data item has been erased from a terminal.

It therefore knows about the use of this security data item at the terminal.

The terminal 21 additionally comprises a PWR functionality 201 for powering the terminal on or off. It also comprises an IF (interface) functionality 204 which is responsible for managing the receiving at the terminal and the transmission of signals from the terminal to a security entity. In one embodiment of the invention, this IF functionality 204 can be responsible for detecting the presence of a security entity. No limitation is placed on the implementation of such detection of the presence of a security entity.

It can be arranged such that the authentication units 61, link management units 62, and receiver 63 are located within the IF functionality 204.

The contactless link between the terminal and the security entity can be NFC (Near Field Communication), for example as described in the standards ISO/IEC 14443, ISO/IEC 18092, and ISO/IEC 21481 (for International Standards Organization/International Electrotechnical Commission). In this case, said link can be established when the distance between the terminal and the identifying entity is between about 4 cm and 10 cm. As this is a relatively small distance, the security level for the link is high and the power consumption is advantageously relatively low at the terminal.

The radio interface between the terminal and the security entity can also be of another type which supports larger distances between the terminal and the security entity, for example as described in the ISO/IEC 15693 standard.

The terminal also has a BB (Baseband) functionality 202 offering the main functions of the terminal when it is powered on via the PWR functionality 201. It also has a CRYPT functionality 203 offering a plurality of security functions to the BB functionality.

In the embodiment described here, the secure functionality is the CRYPT function 203. This function is therefore initially locked. In order to make use of certain functions relying on the CRYPT functionality, possession of a security data item is required.

A part of the CRYPT functionality 203 can be used in the authentication step 21. To do this, the security parameters stored on the terminal are stored in the CRYPT functionality.

In one embodiment of the invention, the IF functionality 204 of the terminal 21 is awakened when there is a transition from the off state to the on state of the PWR functionality. It is possible for the BB functionality 202 not to boot as long as the CRYPT functionality 203 is not unlocked with a corresponding security data item received according to steps 21 to 23 described above. Then, once unlocked, the CRYPT functionality 203 can perform a secure boot of the BB service.

The terminal can then use security parameters derived from security parameters provided by the second management unit in later transactions within the framework of its use within a communication network.

Optionally, the IF functionality 204 sleeps until the next transition from the off state to the on state of the PWR functionality 201, or until a manual action is performed by the user at the terminal.

In another embodiment of the invention, the IF functionality 204 wakes when the PWR functionality 201 of the terminal transitions from off to on and the CRYPT functionality 203 immediately performs a secure boot of the BB functionality even if the security data item has not yet been received.

In this case, the terminal 21 can offer services to the user before receiving the security data item stored on the user's security entity.

To perform the first exchanges of the BB functionality with the network, it can be arranged that the terminal uses certain parameters available to it, in particular an identifier specific to the terminal, denoted terminal_id, and if applicable, a set of security parameters which are also specific to the terminal and managed in the network concerned. Through such a registration in the network, the terminal can advantageously have access to certain services offered in the network when it does not yet have access to the security data item.

In this case, in a parallel or independent manner, the IF functionality 204 of the terminal can detect the presence of a nearby security entity 12. Then, when the presence of such a security entity is detected, steps 21 to 23 of the method according to an embodiment of the invention can be carried out, in order to retrieve the security data item which allows unlocking the CRYPT functionality 203.

Once the security data item is retrieved at the terminal, the terminal is able to perform another registration with the network on the basis of a secure identifier obtained from the security data item retrieved from the security entity, this registration following the registration done on the basis of its own specific identifier, terminal_id. Thus the terminal can advantageously reenroll with the network under its new identity, which is secure and which issues from the security data item.

Once the security data item has been retrieved, it is possible to provide the user with access to a wider variety of services offered on the network.

In addition, once the security data item is retrieved and stored on the terminal, the BB functionality 202 can inform an equipment item in the network 22, for example a network directory server, of the association between the identifier terminal_id and the identity issuing from the security data item.

The procedure for retrieving the security data item can be repeated on a terminal which has already retrieved a security data item, either upon a manual action by the user at the terminal, for example pressing a terminal key or a succession of keys, or by a new transition from the off state to the on state in the PWR functionality 201, which implies that a transition from the on state to the off state has previously occurred.

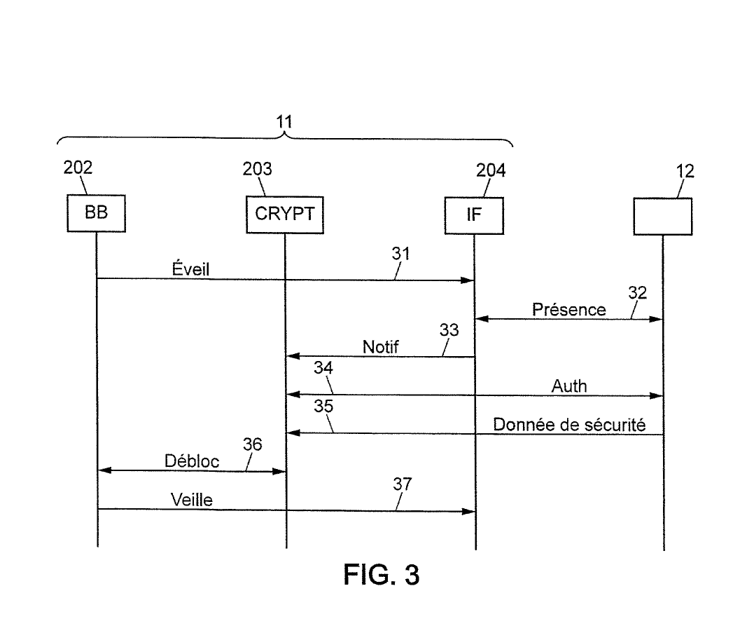

FIG. 3 represents, in one embodiment of the invention, the exchanges of messages concerning identifier management between the BB 202, CRYPT 203, and IF 204 functionalities of a terminal, when the operational state of the PWR functionality passes from Off to On.

A wake command message 31 to the IF functionality 204 is issued by the BB functionality 202. Receipt of this message 31 at the IF functionality 204 triggers a step in which the presence 32 of a user card, or security entity 12, is detected.

When a security entity 12 is detected in the vicinity of the terminal 11, a message 33 notifying of a change of state is sent from the IF functionality 204 to the CRYPT functionality 203.

Then, a mutual authentication 34 is conducted between the CRYPT functionality 203 and the security entity 12 via the IF functionality 204. Following this authentication step, a contactless secure link is established, and the security entity 12 sends the security data item via the IF functionality 204 in an informational message 35.

Upon receipt of this informational message 35, the CRYPT functionality 203 stores the security data item received, via the storage management unit 64.

Then, an exchange of unlocking messages 36 is conducted between the CRYPT functionality 203 and the BB functionality 202, in order to unlock the services offered to the terminal user via the BB functionality 202.

A sleep command message can also be sent by the BB functionality 202 to the IF functionality 204. This sleep command message can advantageously be sent after the unlocking messages 36 have been exchanged. It is therefore possible to put the IF functionality 204 of the terminal to sleep, once the terminal has retrieved the security data item according to an embodiment of the invention.

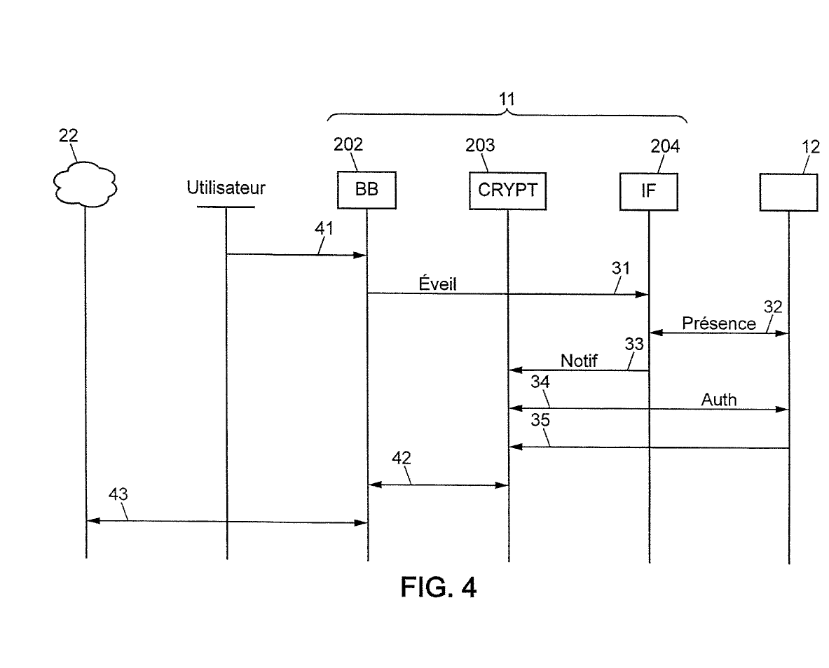

FIG. 4 represents, in an embodiment of the invention, the exchanges of messages within a terminal concerning identifier management between the BB 202, CRYPT 203, and IF 204 functionalities, when the PWR functionality 201 is already in the On operational state and the terminal has already registered with a network on the basis of its own specific identifier.

It can be arranged such that a manual action of the user on the terminal can request a change in the registration with the BB functionality 202. By activating a terminal key or a succession of keys, for example, a change in registration message 41 is sent to the BB functionality 202. Upon receipt of this message 41, the BB functionality 202 sends a wake command message 31 to the IF functionality 204.

This wake command message 31 can be sent by the BB functionality 202 in parallel with other tasks that it carries out after the terminal is already registered with the network on the basis of its own specific identifier, terminal_id. Once the IF functionality 204 is activated, a detection step is performed which detects the presence 32 of a security entity 12.

Then, when the presence of a security entity is detected, the IF functionality 204 changes state and so notifies the CRYPT functionality 203 via a state change notification message 33.

A mutual authentication step 34 between the terminal 11 and the security entity 12 is then performed. Next, the security entity sends the security data item to the terminal by an information message 35 via a contactless secure link. The security data item is then stored in the CRYPT functionality 203.

Once the security data item is stored in the CRYPT functionality 203, the latter functionality initiates an exchange of messages 42 with the BB functionality 202 intended to interrupt the other tasks which are managed in the BB functionality and which concern the services available after the previous registration using the terminal's own specific identifier.

At this point, the terminal 11 has access to the security data item, and is able to use it to determine a secure identifier, on the basis of which it can register with the network 22. For this purpose, an exchange of messages 43 can occur between the BB functionality 202 and the network 22.

Also in this embodiment, the IF functionality 204 can then be put to sleep as is shown in FIG. 3, by the BB functionality 202 sending a sleep message 37 to the IF functionality 204.

In one embodiment of the invention, the security data item can be erased on the terminal where it is stored during the execution of a management method according to an embodiment of the invention.

In fact, so that the terminal can be used by another user, erasure of the security data item originating from the security entity or security card can be performed.

No limitation is placed on the action which triggers such an erasure of secure data on the terminal. Such an erasure procedure can be triggered when the terminal is powered off, meaning when the PWR functionality 201 passes from the On operational state to the Off operational state. It can also be arranged so that when the user presses a key or a succession of keys on the terminal, erasure of this security data item is triggered.

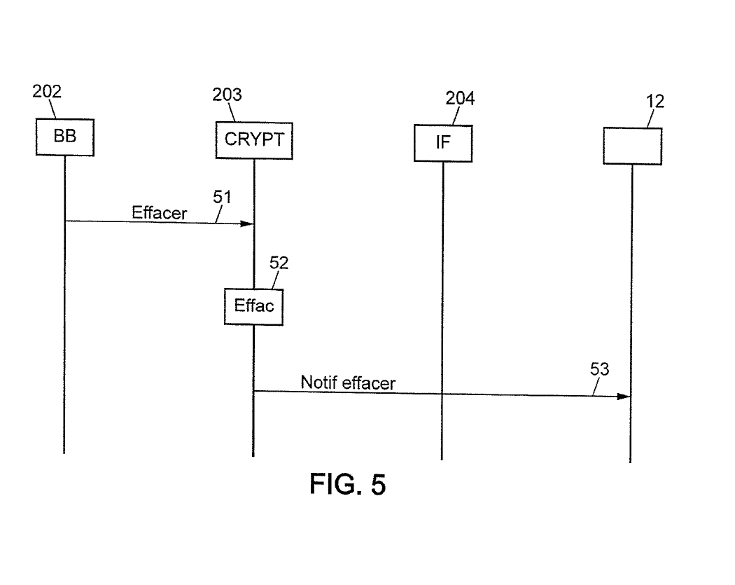

FIG. 5 illustrates an exchange of messages conducted to erase the security data item stored on the terminal according to an embodiment of the invention.

No matter how the security data erasure procedure on the terminal according to an embodiment of the invention is triggered, the BB functionality 202 sends to the CRYPT functionality 203 an erasure message 51 requesting that the CRYPT functionality erase the security data item that it is storing.

In a step 52, this CRYPT functionality 203 erases the stored security data item. Once this step 52 is completed, an erasure notification message 53 is then sent to the security entity 12 via the IF functionality 204.

It should be noted that sending this erasure notification message 53 requires that the IF functionality 204 not be in sleep mode but in active mode. Therefore if this IF functionality 204 is in sleep mode, the BB functionality sends a wake command message 31 to the IF functionality 204 beforehand, ordering it to change its mode.

Alternatively, the security entity can be notified of an erasure of the security data item before the actual erasure of the security data item by the CRYPT functionality 203.

In this manner, the security entity 12 knows whether the security data item stored on it is also stored on a terminal. Such a security entity can therefore manage a utilization state which indicates whether or not the security data item is stored on a terminal.

1. A method for managing the secure use of a terminal having at least one functionality made secure on the basis of a security data item,
with a security entity storing said security data item and first authentication parameters, and
with the terminal storing second authentication parameters,
wherein said method comprises the following steps, at the terminal:
/1/ performing an authentication of the security entity on the basis of first and second authentication parameters,
/2/ establishing a contactless secure link with the security entity,
/3/ receiving, during said contactless secure link, the security data item stored on said security entity, and
/4/ unlocking the secured functionality,
wherein said secured functionality is then used without a link between the security entity and the terminal.

2. The management method according to claim 1, at least one first management unit being in charge of managing security parameters related to terminals and at least one second management unit being in charge of managing security parameters related to users of said terminals,
the first authentication parameters stored on the security entity corresponding to a first security parameter provided by the second management unit and a second security parameter indicating the first management unit,
the second authentication parameters stored on the terminal corresponding to a third security parameter provided by the first management unit and a fourth security parameter indicating the second management unit.

3. The management method according to either of claims 1 or 2, wherein an erasure of the security data item is performed when an action occurs at the terminal, and wherein the terminal notifies the security entity of said erasure.

4. The management method according to claim 1, wherein, prior to step /3/, the terminal registers itself with a network on the basis of an identifier previously stored on the terminal.

5. The management method according to claim 1, wherein, after step /3/, the terminal registers with a network on the basis of a secure identifier obtained using the security data item.

6. A method for managing the secure use of a terminal having at least one functionality made secure on the basis of a security data item,
with a security entity storing said security data item and first authentication parameters, and
with the terminal storing second authentication parameters,
wherein said method comprises the following steps, at the security entity:
/1/ performing an authentication of the terminal on the basis of the first and second authentication parameters,
/2/ establishing a contactless secure link with the terminal, and
/3/ sending to the terminal, during said contactless secure link, the stored security data item.

7. The management method according to claim 6, at least one first management unit being in charge of managing security parameters related to terminals and at least one second management unit being in charge of managing security parameters related to users of said terminals,
the first authentication parameters stored on the security entity corresponding to a first security parameter provided by the second management unit and a second security parameter indicating the first management unit,
the second authentication parameters stored on the terminal corresponding to a third security parameter provided by the first management unit and a fourth security parameter indicating the second management unit.

8. The management method according to claim 6, wherein the security entity manages a utilization state which is updated:
upon transmission of the security data item to a terminal, and
upon receipt of notification that the security data item has been erased from the terminal.

9. A terminal for secure use, having at least one functionality that is made secure on the basis of a security data item stored on a security entity,
said security entity additionally storing first authentication parameters, and
the terminal storing second authentication parameters;
wherein said terminal comprises:
an authentication unit adapted to perform an authentication of the security entity on the basis of the first and second authentication parameters,
a link management unit adapted to establish a contactless secure link with the security entity; and
a receiver adapted to receive, during said contactless secure link, the security data item stored on said security entity, and to unlock said functionality,
wherein said secured functionality is then used without a link between the security entity and the terminal.

10. The terminal according to claim 9, additionally comprising a storage management unit adapted to store the security data item received and to erase said security data item when a specific action occurs.

11. A security entity storing a security data item and adapted to cooperate with a terminal having at least one functionality made secure on the basis of said security data item,
the terminal storing second authentication parameters;
wherein the security entity additionally stores first authentication parameters and comprises:
an authentication unit adapted to perform an authentication of the terminal on the basis of the first and second authentication parameters,
a link management unit adapted to establish a contactless secure link with the terminal; and
a transmitter adapted to transmit the stored security data item during said contactless secure link.

12. The security entity according to claim 11, additionally comprising a state management unit adapted to update a state:
upon transmission of the security data item to a terminal; and
upon receipt of a notification that the security data item has been erased from a terminal.

13. A system for managing the secure use of a terminal, comprising a terminal and a security entity,
wherein the terminal has at least one functionality that is made secure on the basis of a security data item stored on the security entity, said security entity additionally storing first authentication parameters, and the terminal storing second authentication parameters;
wherein said terminal comprises:
an authentication unit adapted to perform an authentication of the security entity on the basis of the first and second authentication parameters,
a link management unit adapted to establish a contactless secure link with the security entity; and
a receiver adapted to receive, during said contactless secure link, the security data item stored on said security entity, and to unlock said functionality,
wherein said secured functionality is then used without a link between the security entity and the terminal; and
wherein the security entity stores the security data item and is adapted to cooperate with the terminal, the terminal storing second authentication parameters;
wherein the security entity comprises:
an authentication unit adapted to perform an authentication of the terminal on the basis of the first and second authentication parameters,
a link management unit adapted to establish a contactless secure link with the terminal; and
a transmitter adapted to transmit the stored security data item during said contactless secure link.
